(19) United States
(12) Patent Application Publication
(10) Pub. No.: US 2015/0275020 A1
(43) Pub. Date: Oct. 1, 2015

(54) UNDERCOATING COMPOSITION FOR IMPERMEABLE RECORDING MEDIUM AND RECORDING MEDIUM FOR AQUEOUS INK

(71) Applicant: TOSHIBA TEC KABUSHIKI KAISHA, Tokyo (JP)

(72) Inventors: Hiroshi KIYOMOTO, Hiratsuka Kanagawa (JP); Takaya KITAWAKI, Mishima Shizuoka (JP)

(21) Appl. No.: 14/663,677

(22) Filed: Mar. 20, 2015

(30) Foreign Application Priority Data
Mar. 28, 2014 (JP) 2014-069823

(51) Int. Cl. C09D 125/08; C09D 175/04; C09D 133/08

(52) U.S. Cl. CPC C09D 125/08; C09D 133/08; C09D 175/04

(57) ABSTRACT

According to one embodiment, an undercoating composition for an impermeable recording medium includes water, matrix resin fine particles, porous resin fine particles, 2,5,8,11-tetramethyl-6-dodecyne-5,8-diol, and a polyvalent metal salt. A recording medium for an aqueous ink includes an impermeable base member, an undercoat layer formed on a surface of the base member. The undercoat layer includes a binder resin, porous resin fine particles, 2,5,8,11-tetramethyl-6-dodecyne-5,8-diol, and a polyvalent metal salt.

### CROSS-REFERENCE TO RELATED APPLICATION

This application is based upon and claims the benefit of priority from Japanese Patent Application No. 2014-069823, filed Mar. 28, 2014, the entire contents of which are incorporated herein by reference.

### FIELD

Embodiments described herein relate generally to an undercoating composition for an impermeable recording medium and a recording medium for an aqueous ink.

### BACKGROUND

Ink jet printing is a printing method in which fine droplets of ink are caused to be discharged and attached on a recording medium. Using the ink jet printing, an image having high image quality can be printed with high speed. The ink jet printing can be applied to industrial printers such as printers that print on a label made of plastic film as well as home-use or office-use printers that print on plain paper. Recently, the ink jet printing is being performed more commonly on impermeable recording media such as plastic, metal, and glass, in addition to permeable recording media such as plain paper. When ink jet printing is performed on an impermeable recording medium, a solvent-based ink, a UV curable ink, a two-liquid type curing ink, or the like have been used. However, the solvent-based ink usually has a solvent odor and contains harmful materials in the volatile components of the solvent. In addition, a curable monomer included in the UV curable ink and the two-liquid type curing ink usually contains harmful materials. To deal with these issues, when ink jet printing is performed on an impermeable recording medium, it is desirable to use a water-based ink, which usually contains less harmful materials.

In general, plain paper, which is a permeable recording medium, is formed of intertwined fibers, and has a porous structure or a capillary structure. According to the porous structure or the capillary structure, when ink jet printing is performed on a permeable recording medium with a water-based ink, the ink is likely to penetrate into the structure, and the recording medium tends to dry quickly. In addition, beading is less likely, and adhesion of the ink is improved. “Beading” is a phenomenon where adjacent ink dots on a recording medium merge, and causes density unevenness or color unevenness of the image, which leads to lower quality of the printed image.

On the other hand, when ink jet printing is performed on an impermeable recording medium with the water-based ink, the ink does not permeate the recording medium. Thus, the following issues arise: (1) the drying time of the ink is longer; (2) beading is likely to be produced; and (3) the adhesion of the ink on the recording medium is weak.

According to a related art, an undercoat layer is coated on an impermeable recording medium before the ink jet printing is performed. However, the undercoat layer is not sufficient to deal with the issues (1) to (3).

### DETAILED DESCRIPTION

One or more exemplary embodiments provide an undercoating composition for an impermeable recording medium which is possible to shorten the drying time, reduce beading, improve the image quality of printing and improve the adhesion of an ink, and a recording medium for an aqueous ink.

In general, according to one embodiment, the undercoating composition for an impermeable recording medium of an exemplary embodiment includes water, matrix resin fine particles, porous resin fine particles, 2,5,8,11-tetramethyl-6-dodecyne-5,8-diol, and a polyvalent metal salt.

Hereinafter, the undercoating composition for an impermeable recording medium (hereinafter, referred to as “undercoating composition”) of the exemplary embodiment will be described.

The undercoating composition of the exemplary embodiment is used to form an undercoat layer by coating the surface of an impermeable recording medium before ink jet printing or writing characters or the like using a fountain pen, a ballpoint pen, or the like.

Examples of the impermeable recording medium include plastic, metal, glass, ceramics, and concrete. Examples of the plastic include polyvinyl chloride, polyethylene terephthalate, and resin-based synthetic paper. Examples of the metal include copper and stainless steel.

The type of ink of ink jet printing, a fountain pen, a ballpoint pen, or the like is not particularly limited as long as the ink is an aqueous ink. From the viewpoint of ease for obtaining the effects of the exemplary embodiment, the type of the ink is preferably an aqueous ink used in ink jet printing.

In the undercoating composition of the exemplary embodiment, water serves as a solvent or a dispersion medium. The type of the water, which is not particularly limited, is preferably purified water such as ion exchange water and distilled water.

In the undercoating composition of the exemplary embodiment, the matrix resin fine particles are dispersed in the water.

The undercoating composition of the exemplary embodiment is coated on the surface of an impermeable recording medium and dried, whereby the matrix resin fine particles become a binder resin of the undercoat layer. The binder resin improves fixability of the undercoat layer to the impermeable recording medium, abrasion resistance or water resistance of printing.

Examples of the resin component of the matrix resin fine particles include an acrylic acid resin, a methacrylic acid resin, a styrene resin, a urethane resin, a maleic acid resin, an acryl amide resin, an epoxy resin, and mixtures of these. In addition, the resin component of the matrix resin fine particles may be a block copolymer, a random copolymer, a graft copolymer, or the like.

Among these, the resin component of the matrix resin fine particles is preferably an acrylic acid resin, a methacrylic acid resin, or mixtures of these.

The resin component of the matrix resin fine particles may be only one kind or may be a combination of two or more kinds thereof.

When the matrix resin fine particles are a mixture of two or more resin components, the shape of the matrix resin fine particles is preferably a core shell type. An example of the matrix resin fine particles of the core shell type is matrix resin fine particles in which the core portion is a hydrophobic acrylic resin, and the shell portion is an aqueous urethane resin or an acrylic graft aqueous urethane resin.

The melting point of the matrix resin fine particles is preferably 100° C. to 300° C. When the melting point of the matrix resin fine particles is in the above range, the undercoat layer can be more uniformly formed on the impermeable recording medium.

The volume average particle size of the matrix resin fine particles is preferably 0.01 μm to 1 μm, and more preferably 0.05 μm to 0.2 μm. When the volume average particle size of the matrix resin fine particles is equal to or greater than the lower limit value, it is possible to prevent viscosity from increasing over time of the undercoating composition. On the other hand, when the volume average particle size of the matrix resin fine particles is equal to or less than the upper limit value, it is possible to suppress precipitation of the matrix resin fine particles in the undercoating composition.

The concentration of the matrix resin fine particles in the undercoating composition is not particularly limited, and suitably set. The concentration of the matrix resin fine particles in the undercoating composition is preferably 5% by mass to 50% by mass, and more preferably 10% by mass to 40% by mass. When the concentration of the matrix resin fine particles is equal to or greater than the lower limit value, the fixability of the undercoat layer to the impermeable recording medium becomes better. On the other hand, when the concentration of the matrix resin fine particles is equal to or less than the upper limit value, coating of the undercoat composition on the surface of the impermeable recording medium does not become too difficult.

In the undercoating composition of the exemplary embodiment, the porous resin fine particles are dispersed in the water.

The porous resin fine particles of the exemplary embodiment may have porous or small-porous. Examples of the porous resin fine particles include hollow resin fine particles having a hollow structure in the resin fine particles, porous resin fine particles having pores in the resin fine particles, or hollow porous resin fine particles having a hollow structure in the resin fine particles and pores going through the hollow structure from the resin fine particle surface.

In the exemplary embodiment, for example, when ink jet printing is performed on an impermeable recording medium with an undercoat layer having an undercoating composition, a solvent or a dispersion medium in an ink is separated from a solid content such as a pigment in the ink, and is quickly absorbed into hollow structures or into pores. As the solid content such as the pigment in the ink is quickly dried on the undercoat layer, the time during which the ink remains in a liquid state on the recording medium is reduced, and thus adjacent dots are less likely to merge. Furthermore, for the same reason, as the solid content in the dots is likely to be uniformly dried, the dots are less likely to become uneven.

As described the above, beading of the ink is less likely to occur, and image quality of printing can be improved.

The porous resin fine particles are preferably hollow resin fine particles or hollow porous resin fine particles, and the hollow porous resin fine particles are more preferable. When the porous resin fine particles have the hollow structure, an amount of a solvent or a dispersion medium in an ink in the pores is further increased, and the absorption rate of the solvent or the dispersion medium in the ink into hollow structures or pores is further increased.

Therefore, since the solid content such as the pigment in the ink is more quickly dried on the undercoat layer, the time during which the ink remains in a liquid state on the recording medium is further reduced, and thus adjacent dots are less likely to merge. Furthermore, for the same reason, since the solid content in the dots is likely to be more uniformly dried, the dots are less likely to become uneven.

As described above, beading is further less likely to occur, and image quality of printing can be further improved.

Examples of the resin component of the porous resin fine particles include a styrene resin, a copolymer of styrene and acrylic acid, a polyethylene resin, a polypropylene resin, a melamine resin, and a nylon resin. Among these, from a viewpoint of further improving the effects of the exemplary embodiment, the copolymer of styrene and acrylic acid is preferable.

The resin component of the porous resin fine particles may be only one kind or may be a combination of two or more kinds thereof.

The melting point of the porous resin fine particles is preferably 100° C. to 300° C. When the melting point of the porous resin fine particles is in the above range, the absorptivity of a solvent or a dispersion medium in an ink into an undercoat layer is more stable.

The volume average particle size of the porous resin fine particles is preferably 0.1 μm to 3 μm, and more preferably 0.3 μm to 1 μm. When the volume average particle size of the porous resin fine particles is equal to or greater than the lower limit value, a solvent or a dispersion medium in an ink is likely to be more quickly absorbed by an undercoat layer. On the other hand, when the volume average particle size of the porous resin fine particles is equal to or less than the upper limit value, glossiness of the undercoat layer is preferable.

Regarding the porous resin fine particles, the proportion of the volume of the inner portions of hollow structures or pores with respect to the volume of the resin portion is preferably 40% to 60%. When the proportion is equal to or greater than the lower limit value, a solvent or a dispersion medium in an ink is likely to be more quickly absorbed into an undercoat layer when the ink is applied on a recording medium. On the other hand, when the proportion is equal to or less than the upper limit value, a solvent or a dispersion medium in an ink is likely to be separated from a solid content such as a pigment in the ink when the solvent or the dispersion medium in the ink is absorbed into an undercoat layer.

The number of pores, which is not particularly limited, is preferably set such that after forming an undercoat layer, pores which are open on the surface side of the layer are present.

The pore diameter, which is not particularly limited, is preferably smaller than the particle size of the pigment included in an ink.

The depth of pores is not particularly limited. When the porous resin fine particles does not have the hollow structure in the inner portion, pores preferably reach from the surface of the porous resin fine particles to the center portion. When the porous resin fine particles have the hollow structure in the inner portion, pores preferably reach from the surface of the porous resin fine particles to the hollow structure.

The concentration of the porous resin fine particles in the undercoating composition can be suitably set. The concentration of the porous resin fine particles in the undercoating composition is preferably 5% by mass to 50% by mass, and more preferably 10% by mass to 40% by mass. When the concentration of the porous resin fine particles is equal to or greater than the lower limit value, a solvent or a dispersion medium in an ink is likely to be more quickly absorbed by an undercoat layer. On the other hand, when the concentration of the porous resin fine particles is equal to or less than the upper limit value, coating of the undercoat composition on the surface of the impermeable recording medium does not become too difficult, and the adhesion of the undercoat layer and the impermeable recording medium is improved.

2,5,8,11-Tetramethyl-6-dodecyne-5,8-diol (hereinafter, referred to as “TDD”) of the exemplary embodiment is a wetting agent. With such a wetting agent, the wettability of the inner surfaces of pores of the porous resin fine particles is improved. When the porous resin fine particles have the hollow structures, TDD improves the wettability of the inner surfaces of pores or the inner surfaces of hollow structures.

As the wettability of the inner surfaces of pores or the inner surfaces of hollow structures of the porous resin fine particles is improved with TDD, a solvent or a dispersion medium in an ink is quickly absorbed into the porous resin fine particles. Further, as the solid content such as the pigment in the ink is quickly dried on the undercoat layer, the time remaining in a liquid state on the recording medium of the ink is reduced, and thus adjacent dots are less likely to merge. Furthermore, for the same reason, as the solid content in the dots is likely to be uniformly dried, the dots are less likely to become uneven.

As described above, beading is reduced, and image quality of printing can be improved.

The concentration of TDD in the undercoating composition is preferably 0.1% by mass to 5% by mass, and more preferably 0.3% by mass to 3% by mass. When the concentration of TDD is in the above range, the wettability of the inner surfaces of pores or the inner surfaces of hollow structures of the porous resin fine particles is further improved.

The polyvalent metal salt of the exemplary embodiment has a function of suppressing bleeding or color bleed of an ink during the ink jet printing. With the function, image quality of printing can be improved.

Examples of the metal ion contained in the polyvalent metal salt include divalent ions such as Ca²⁺, Cu²⁺, Ni²⁺, Mg²⁺, Zn²⁺, and Ba²⁺, and trivalent ions such as Al³⁺ and Fe³⁺. Among these, Ca²⁺ is preferable because the dissolution stability in water is high.

Among polyvalent metal salts containing Ca²⁺, calcium lactate is preferable.

The concentration of the polyvalent metal salt in the undercoating composition is preferably 0.1% by mass to 5% by mass, and more preferably 0.1% by mass to 3% by mass. When the concentration is in the above range, bleeding or color bleed of an ink can be further sufficiently suppressed.

The undercoating composition of the exemplary embodiment preferably contains a surface tension adjuster, a water-soluble organic solvent, and a penetrating agent, in addition to water, matrix resin fine particles, porous resin fine particles, TTD, and a polyvalent metal salt described above.

The surface tension adjuster can further improve the wettability of the inner surfaces of pores or the inner surfaces of hollow structures of the porous resin fine particles, and makes a solvent or a dispersion medium in an ink more easily penetrate into the porous resin fine particles.

In addition, the surface tension adjuster is effective when a recording medium on which the undercoating composition of the exemplary embodiment is coated is for inkjet printing, or when printing is performed by a bar coater. However, since spread of the ink discharged by ink jet printing on the undercoat layer is suppressed, and the beading is suppressed, the surface tension adjuster is particularly effective when a recording medium is for ink jet printing.

As the surface tension adjuster, surfactants are preferable. Among the surfactants, an anionic surfactant and a nonionic surfactant are preferable.

Examples of the anionic surfactant include fatty acid salts, a higher alkyl dicarboxylic acid salt, higher alcohol sulfuric acid ester salts, a higher alkyl sulfonate, a condensate of higher fatty acid and amino acid, a sulfosuccinic acid ester salt, a naphthenate, liquid fatty oil sulfuric acid ester salts, an alkyl allyl sulfonate, a polyoxyethylene alkyl ether carboxylate, a polyoxyethylene alkyl ether sulfuric acid ester salt, and a polyoxyethylene alkyl ether phosphate.

Examples of the nonionic surfactant include polyoxyethylene alkyl ethers, polyoxyethylene alkyl esters, sorbitan alkyl esters, polyoxyethylene sorbitan alkyl esters, and acetylene glycols.

The concentration of the surface tension adjuster in the undercoating composition is preferably 0.5% by mass to 3% by mass. When the concentration is in the above range, the wettability of the inner surfaces of pores or the inner surfaces of hollow structures of the porous resin fine particles is further improved, and a solvent or a dispersion medium in an ink is more quickly absorbed into the porous resin fine particles. As the solid content such as the pigment in the ink is more quickly dried on the undercoat layer, the time remaining in a liquid state on the recording medium of the ink is reduced, and thus adjacent dots are less likely to merge. Furthermore, as the solid content in the dots is likely to be more uniformly dried, the dots are less likely to become uneven. In addition, when the surface tension adjuster that has the concentration in the above range is used in a recording medium for ink jet printing, spread of the ink discharged on the undercoat layer is further suppressed, and occurrence of beading is further suppressed.

As described above, beading is further reduced, and image quality of printing can be further improved.

The water-soluble organic solvent has a function as a wetting agent which prevents the undercoating composition from being dried.

Examples of the water-soluble organic solvent include polyols, nitrogen-containing heterocyclic compounds, amines, and sulfur-containing compounds.

Examples of the polyol include ethylene glycol, diethylene glycol, triethylene glycol, polyethylene glycol, dipropylene glycol, polypropylene glycol, 1,5-pentanediol, 1,6-hexanediol, glycerin, 1,2,6-hexanetriol, 1,2,4-butanetriol, 1,2,3-butanetriol, and 3-methyl-1,3,5-pentanetriol.

Examples of the nitrogen-containing heterocyclic compound include N-methyl-2-pyrrolidone, N-hydroxyethyl-2-pyrrolidone, 2-pyrrolidone, 1,3-dimethylimidazolidinone, and ε-caprolactam.

Examples of the amines include monoethanolamine, diethanolamine, triethanolamine, monoethylamine, diethylamine, and triethylamine.

Examples of the sulfur-containing compound include dimethyl sulfoxide, sulfolane, and thiodiethanol.

Examples of a water-soluble organic solvent other than polyols, nitrogen-containing heterocyclic compounds, amines, and sulfur-containing compounds include propylene carbonate, ethylene carbonate, and γ-butyrolactone.

Among these water-soluble organic solvents, from the viewpoint of higher water holding property and difficulty in being volatilized due to a high boiling point, glycerin is preferable.

The water-soluble organic solvent in the undercoating composition may be only one kind or may be a combination of two or more kinds thereof.

In addition, to further improve the wetting effect by the water-soluble organic solvent, a solid wetting agent such as urea, thiourea, or ethylene urea may be used in combination.

The concentration of the water-soluble organic solvent in the undercoating composition is preferably 1% by mass to 20% by mass, and more preferably 1% by mass to 10% by mass. When the concentration is in the above range, the function as the wetting agent is sufficiently achieved.

When glycerin is used as the water-soluble organic solvent, the proportion of glycerin in the water-soluble organic solvent is preferably equal to or greater than 50% by mass.

The penetrating agent is preferably 3-methoxy-3-methyl-1-butanol. 3-Methoxy-3-methyl-1-butanol has a function to promote the TDD to penetrate into the pores or hollow structures of the porous resin fine particles. According to the function, the wettability of the inner surfaces of pores or the inner surfaces of hollow structures of the porous resin fine particles is further improved, and a solvent or a dispersion medium in an ink is more quickly absorbed into the porous resin fine particles. As the solid content such as the pigment in the ink is more quickly dried on the undercoat layer, the time remaining in a liquid state on the recording medium of the ink is reduced, and thus adjacent dots are less likely to merge. Furthermore, as the solid content in the dots is likely to be more uniformly dried, the dots are less likely to become uneven. As described above, beading is further reduced, and image quality of printing can be further improved.

The undercoating composition of the exemplary embodiment may include other additives in addition to water, matrix resin fine particles, porous resin fine particles, TDD, a polyvalent metal salt, a surface tension adjuster, a water-soluble organic solvent, and a penetrating agent described above.

Examples of other additives include an inorganic filler, a pH adjuster, and a preservative and fungicide.

Examples of the inorganic filler include silica, calcium carbonate, and alumina.

Examples of the pH adjuster include sodium hydroxide, potassium hydroxide, potassium dihydrogenphosphate, and disodium hydrogenphosphate.

Examples of the preservative and fungicide include sodium benzoate, sodium pentachlorophenolate, sodium 2-pyridinethiol-1-oxide, sodium sorbate, sodium dehydroacetate, and 1,2-dibenzisothiazolin-3-one.

The production of the undercoating composition of the exemplary embodiment is performed by suitably mixing respective components. For example, first, a suitable amount of water is prepared in a container. Then, other components are added while stirring the water.

When matrix resin fine particles and porous resin fine particles are added to water and the mixture is stirred, the matrix resin fine particles are dispersed to form an emulsion.

Stirring is performed by a stirring method used in general, for example, a method using a stirrer.

The stirring intensity is suitably adjusted so that other components can be quickly and sufficiently dispersed in water, liquid is not overflowed from the container, and foams are not produced.

The stirring time is suitably set so that other components can be sufficiently dispersed in water at the stirring intensity.

The dispersion obtained by stirring may be filtered by a filter to remove large particles or impurities such as dust. The pore size of the filter is preferably 3 μm to 10 μm.

The recording medium for an aqueous ink of the exemplary embodiment is an impermeable recording medium on which an undercoat layer is formed. The undercoat layer includes a binder resin, porous resin fine particles, TDD, and a polyvalent metal salt. The binder resin has a function of fixing the undercoat layer to the impermeable recording medium.

In the recording medium for an aqueous ink, the porous resin fine particles are dispersed in a mixture of a binder resin, TDD, and a polyvalent metal salt.

In the recording medium for an aqueous ink, TDD, other than being mixed in the mixture, improves the wettability of the inner surfaces of pores or the inner surfaces of hollow structures by penetrating into the inner portions of pores or the inner portions of hollow structures of the porous resin fine particles and being adhered to the inner surfaces of the pores or the inner surfaces of the hollow structures.

From the viewpoint of ease to further enjoy the effects of the exemplary embodiment, the recording medium for an aqueous ink is preferably a recording medium for ink jet printing.

In the exemplary embodiment, the undercoat layer is formed by coating the undercoating composition on the impermeable recording medium and performing drying.

The undercoating composition of the exemplary embodiment is coated on the surface of the impermeable recording medium and dried, whereby the matrix resin fine particles in the undercoating composition become a binder resin.

The coating method is not particularly limited, and may be a known coating method. A coating method using a bar coater can be employed.

The drying method is not particularly limited, and may be natural drying or be drying by heating. From the viewpoint of easily achieving a function as a binder resin by melting the matrix resin fine particles, the drying method is preferably drying by heating. When drying by heating is performed, a known heater such as a dryer is suitably used.

As described above, according to the exemplary embodiment, when the undercoating composition has water, matrix resin fine particles, porous resin fine particles, TDD, and a polyvalent metal salt, it is possible to shorten the drying time of an ink, reduce the beading, improve the image quality of printing, and improve the adhesion of the ink.

According to at least one exemplary embodiment described above, when the undercoating composition has water, matrix resin fine particles, porous resin fine particles, TDD, and a polyvalent metal salt, a solvent or a dispersion medium in an ink is quickly absorbed into the porous resin fine particles by improvement in the wettability by TDD, and thus the drying time of the ink can be shortened in comparison with a case where an undercoat layer is not used. In addition, according to the same mechanism, the beading is reduced, and the image quality of printing is improved.

In addition, when the ink is dried after printing, the solid content such as a pigment in the ink is adhered onto the recording medium. In general, the solid content has low adhesion with respect to the surface of the impermeable recording medium, and thus the printed material is easily peeled off or damaged. In the exemplary embodiment, the adhesion of the solid content with respect to an undercoat layer of a recording medium for an aqueous ink is higher in comparison with the adhesion with respect to the surface of the impermeable recording medium. Therefore, when using the recording medium for an aqueous ink of the exemplary embodiment, the printed material is less likely to be peeled off or damaged.

### EXAMPLES

The following description is examples of the exemplary embodiment. However, the exemplary embodiment is not limited to the Examples.

### Examples 1 to 6

Hereinafter, the method for producing undercoating compositions of Examples 1 to 6 will be described.

The followings were used as raw materials.

Matrix resin fine particles A: Styrene-acrylic acid copolymer (“Mowinyl 745”, manufactured by Nippon Synthetic Chemical Industry Co., Ltd.)

Matrix resin fine particles B: Acrylic ester copolymer (“VINYBLAN 2684”, manufactured by Nissin Chemical Co., Ltd.)

Matrix resin fine particles C: Styrene-maleic acid copolymer (“VE-1122”, manufactured by SEIKO PMC CORPORATION)

Matrix resin fine particles D: Core shell type (core portion: hydrophobic acrylic resin, shell portion: aqueous urethane) (“WEM type A”, manufactured by TAISEI FINE CHEMICAL CO., LTD.)

Matrix resin fine particles E: Core shell type (core portion: hydrophobic acrylic resin, shell portion: acrylic graft aqueous urethane) (“WEM type B”, manufactured by TAISEI FINE CHEMICAL CO., LTD.)

Porous resin fine particles F: Styrene-acrylic acid copolymer (“Type U”, manufactured by R company, volume average particle size of 0.5 μm)

Porous resin fine particles G: Styrene-acrylic acid copolymer (“MH8101”, manufactured by ZEON CORPORATION, volume average particle size of 1.0 μm)

Porous resin fine particles H: Styrene-acrylic acid copolymer (“PTT8374”, manufactured by ZEON CORPORATION, volume average particle size of 1.1 μm)

TDD (manufactured by Air Products and Chemicals, Inc.)

Nonionic surfactant: NIKKOL-BT7 (manufactured by Nikko Chemicals Co., Ltd.)

Calcium lactate (manufactured by Musashino Chemical Laboratory, Ltd.)

MMB: 3-Methoxy-3-methyl-1-butanol (manufactured by KURARAY Co., Ltd.)

Preservative and fungicide: Proxel XL-2 (manufactured by Arch Chemicals)

Propylene glycol (manufactured by Asahi Glass Co., Ltd.)

Dipropylene glycol (manufactured by Asahi Glass Co., Ltd.)

Triethylene glycol (manufactured by Maruzen Petrochemical Co., Ltd.)

Polyethylene glycol #200 (manufactured by Sanyo Chemical Industries, Ltd.)

Polyethylene glycol #400 (manufactured by Sanyo Chemical Industries, Ltd.)

Glycerin (manufactured by Sakamoto Yakuhin Kogyo Co., Ltd.)

First, other components were added to pure water at the mixing ratios shown in Table 1, the mixture was stirred for 1 hour with a stirrer, and as a result a dispersion was obtained. Then, the dispersion was filtered with a filter having a pore size of 1 μm, and whereby respective undercoating compositions of Examples 1 to 6 were produced.

TABLE 1

| Composition (% by mass) | Example 1 | Example 2 | Example 3 | Example 4 | Example 5 | Example 6 |
|---|---|---|---|---|---|---|
| Matrix resin fine particles A | 20 | — | — | 10 | — | — |
| Matrix resin fine particles B | — | 20 | — | 10 | — | — |
| Matrix resin fine particles C | — | — | 20 | — | — | — |
| Matrix resin fine particles D | — | — | — | — | 20 | — |
| Matrix resin fine particles E | — | — | — | — | — | 20 |
| Porous fine particles F | 10 | — | 10 | — | — | — |
| Porous fine particles G | — | 20 | — | 20 | 20 | 20 |
| Porous fine particles H | — | — | 10 | — | — | — |
| TDD | 1 | 1 | 1 | 1 | 1 | 1 |
| NIKKOL-BT7 | 1 | 1 | 1 | 1 | 1 | 1 |
| Calcium lactate | 0.2 | 0.2 | 0.2 | 0.2 | 0.2 | 0.2 |
| MMB | — | — | — | — | 1 | 1 |
| Preservative | 0.2 | 0.2 | 0.2 | 0.2 | 0.2 | 0.2 |
| Propylene glycol | 10 | — | 5 | — | — | — |
| Dipropylene glycol | — | 10 | — | — | — | — |
| Triethylene glycol | 5 | — | — | — | — | — |
| Polyethylene glycol #200 | — | — | — | 10 | — | — |
| Polyethylene glycol #400 | — | — | 10 | — | 5 | — |
| Glycerin | — | — | — | — | 5 | 10 |
| Water | 52.6 | 47.6 | 42.6 | 47.6 | 46.6 | 46.6 |
| Total | 100 | 100 | 100 | 100 | 100 | 100 |

Then, a method for forming an undercoat layer on an impermeable recording medium using the undercoating compositions of Examples 1 to 6 will be described.

As the impermeable recording medium, general-purpose products having following materials were used.

Polyvinyl chloride (PVC)

Polypropylene (PP)

Polyethylene terephthalate (PET)

Copper

Stainless steel

Glass

The undercoating compositions of Examples 1 to 6 were coated on plates made of the materials shown in Table 1 in the amount of about 4 g/m². The coated undercoating compositions were heated and dried by a dryer.

As a result, impermeable recording media on which undercoat layers were formed using the undercoating compositions of Examples 1 to 6 were produced.

Next, evaluation of the impermeable recording media on which undercoat layers were formed will be described.

First, 70% by mass of pure water, 25% by mass of carbon black, and 5% by mass of polyoxyethylene anionic surfactant were added to the cylinder of a bead mill. Then, the carbon black and the polyoxyethylene anionic surfactants were dispersed in the pure water by zirconia beads. After sufficiently dispersing, the zirconia beads were removed from the dispersion. Coarse particles were removed from the dispersion by centrifugal separation and filtration through a filter having a pore size of 1 μm. As a result, a black dispersion was produced.

Then, 20% by mass of the black dispersion, 20% by mass of matrix resin fine particles A, 10% by mass of glycerin, 1% by mass of TDD, 1% by mass of NIKKOL-BT7, 1% by mass of MMB, 0.2% by mass of Proxel XL-2, and 46.8% by mass of pure water were mixed. As a result, a black ink was produced.

Then, the black ink was inkjet-printed on the undercoat layers formed on the impermeable recording media using the undercoating compositions of Examples 1 to 6. Printing was performed with 100% duty in an area of 10 mm×10 mm using an inkjet recording apparatus equipped with a piezoelectric head (600 dpi) manufactured by TOSHIBA TEC CORPORATION. The printed black ink was dried by treating the surface of the impermeable recording medium at 50° C. for 10 seconds by a dryer.

The density (OD value) of the printed image was measured by a spectroscopic densitometer (“X-Rite”, manufactured by X-Rite Inc.).

Evaluation of beading of the printed image was visually performed according to the following criteria.

A: Beading was not produced at all.

B: Beading was produced at several places.

C: Beading was produced at ten places or more.

D: Beading was produced on the entire surface.

Evaluation of adhesion of the ink with respect to the recording medium was performed as follows.

An adhesive tape (“Scotch mending tape”, manufactured by Sumitomo 3M Limited) was attached on the printed surface, then rubbed with a finger three times, and the adhesive tape was detached. The printed surface of the portion at which the adhesive tape was detached was visually evaluated according to the following criteria.

B: Ink was not peeled off at all from the impermeable recording medium.

C: Ink was partially peeled off from the impermeable recording medium.

D: Ink was significantly peeled off from the impermeable recording medium.

Evaluation results of the image densities, beadings, and adhesions in Examples 1 to 6 are shown in the following Table 2.

As a result, the image densities in Examples 1 to 6 were equal to or greater than 1.85, and were preferable.

In addition, evaluations of the beadings in Examples 1 to 6 were equal to or higher than B, and these results were preferable.

In addition, evaluations of adhesions in Examples 1 to 6 were B, and these results were preferable.

In particular, the image densities in Examples 5 and 6 in which MMB was included were equal to or greater than 2.21, and the image quality was excellent. In addition, evaluations of beadings in Examples 5 and 6 were A, and reduction of beading was excellent.

TABLE 2

| Kind of impermeable | | Vinyl | | | | Stainless | |
|---|---|---|---|---|---|---|---|
| recording medium | | chloride | PP | PET | Copper | Steel | Glass |
| | Evaluation | | | | | | |
| | item | Example 1 | Example 2 | Example 3 | Example 4 | Example 5 | Example 6 |
| Undercoat | Image | 1.85 | 2.18 | 2.06 | 2.13 | 2.21 | 2.25 |
| layer is | density | | | | | | |
| present | Beading | B | B | B | B | A | A |
| | Adhesion | B | B | B | B | B | B |
| | Evaluation | Comparative | Comparative | Comparative | Comparative | Comparative | Comparative |
| | item | Ex 1 | Ex 2 | Ex 3 | Ex 4 | Ex 5 | Ex 6 |
| Undercoat | Image | Unmea- | Unmea- | 1.63 | 1.58 | 1.71 | 1.75 |
| layer is | density | sured | sured | | | | |
| not | Beading | D | D | C | C | C | C |
| present | Adhesion | D | D | C | C | C | C |

### Comparative Examples 1 to 6

In Comparative Examples 1 to 6, evaluations were performed in the same manner as in Examples 1 to 6 except that an undercoat layer was not formed on the impermeable recording medium.

Evaluation results of the image densities, beadings, and adhesions in Comparative Examples 1 to 6 are shown in Table 2. With respect to Comparative Examples 1 and 2, as beading was produced significantly and adhesions of the inks were poor, measurement of the image density was not performed.

Specifically, the image densities in Comparative Examples 3 to 6 were equal to or less than 1.75, and were poorer than Examples 1 to 6.

In addition, evaluations of beadings in Comparative Examples 1 to 6 were equal to or less than C, and were poorer than Examples 1 to 6.

In addition, evaluations of adhesions in Comparative Examples 1 to 6 were equal to or less than C, and the adhesions were poorer than Examples 1 to 6.

In particular, evaluations of beadings in Comparative Examples 1 and 2 were D. In addition, evaluations of adhesions in Comparative Examples 1 and 2 were D. That is, the beadings and adhesions in Comparative Examples 1 and 2 were much poorer than Examples 1 to 6.

### Comparative Examples 7 to 12

In Comparative Examples 7 to 12, undercoat layers were formed on the impermeable recording media in the same manner as in Examples 1 to 6 except that porous fine particles were not added, and evaluations were performed.

Evaluation results of the image densities, beadings, and adhesions in Comparative Examples 7 to 12 are shown in Table 3.

As a result, the image densities in Comparative Examples 7 to 12 were equal to or less than 1.63, and were poorer than Examples 1 to 6.

In addition, evaluations of beadings in Comparative Examples 7 to 12 were D, and the beadings were much poorer than Examples 1 to 6.

In addition, evaluations of adhesions in Comparative Examples 7 to 12 were C, and the adhesions were poorer than Examples 1 to 6.

TABLE 3

| Kind of impermeable | | Vinyl | | | | Stainless | |
|---|---|---|---|---|---|---|---|
| recording medium | | chloride | PP | PET | Copper | steel | Glass |
| | Evaluation | Comparative | Comparative | Comparative | Comparative | Comparative | Comparative |
| | item | Ex 7 | Ex 8 | Ex 9 | Ex 10 | Ex 11 | Ex 12 |
| Porous | Image | 1.47 | 1.42 | 1.55 | 1.46 | 1.59 | 1.63 |
| resin fine | density | | | | | | |
| particles | Beading | D | D | D | D | D | D |
| are not | Adhesion | C | C | C | C | C | C |
| present | | | | | | | |
| | Evaluation | Comparative | Comparative | Comparative | Comparative | Comparative | Comparative |
| | item | Ex 13 | Ex 14 | Ex 15 | Ex 16 | Ex 17 | Ex 18 |
| TDD is | Image | 1.58 | 1.46 | 1.62 | 1.52 | 1.53 | 1.44 |
| not | density | | | | | | |
| present | Beading | C | C | C | C | C | C |
| | Adhesion | C | C | C | C | C | C |
| | Evaluation | Comparative | Comparative | Comparative | Comparative | Comparative | Comparative |
| | item | Ex 19 | Ex 20 | Ex 21 | Ex 22 | Ex 23 | Ex 24 |
| Polyvalent | Image | 1.53 | 1.36 | 1.58 | 1.47 | 1.55 | 1.4 |
| metal salt | density | | | | | | |
| is not | Beading | B | B | B | B | B | B |
| present | Adhesion | B | B | B | B | B | B |

### Comparative Examples 13 to 18

In Comparative Examples 13 to 18, undercoat layers were formed on the impermeable recording media in the same manner as in Examples 1 to 6 except that TDD was not added, and evaluations were performed.

Evaluation results of the image densities, beadings, and adhesions in Comparative Examples 13 to 18 are shown in Table 3.

As a result, the image densities in Comparative Examples 13 to 18 were equal to or less than 1.62, and were poorer than Examples 1 to 6.

In addition, evaluations of beadings in Comparative Examples 13 to 18 were C, and the beadings were poorer than Examples 1 to 6.

In addition, evaluations of adhesions in Comparative Examples 13 to 18 were C, and the adhesions were poorer than Examples 1 to 6.

### Comparative Examples 19 to 24

In Comparative Examples 19 to 24, undercoat layers were formed on the impermeable recording media in the same manner as in Examples 1 to 6 except that polyvalent metal salt was not added, and evaluations were performed.

Evaluation results of the image densities, beadings, and adhesions in Comparative Examples 19 to 24 are shown in Table 3.

As a result, evaluations of beadings in Examples 19 to 24 were B, and these results were preferable.

In addition, evaluations of adhesions in Examples 19 to 24 were B, and these results were preferable.

However, the image densities in Comparative Examples 19 to 24 were equal to or less than 1.58, and were poorer than Examples 1 to 6.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An undercoating composition for an impermeable recording medium, comprising:
water;
matrix resin fine particles;
porous resin fine particles;
2,5,8,11-tetramethyl-6-dodecyne-5,8-diol; and
a polyvalent metal salt.

2. The composition according to claim 1, further comprising:
a surface tension adjuster.

3. The composition according to claim 1, further comprising:
a water-soluble organic solvent.

4. The composition according to claim 1, wherein
the porous resin fine particles are formed of a copolymer of a styrene resin and an acrylic resin.

5. The composition according to claim 1, further comprising:
a penetrating agent.

6. The composition according to claim 5, wherein
the penetrating agent includes 3-methoxy-3-methyl-1-butanol.

7. The composition according to claim 1, wherein
the polyvalent metal salt includes calcium lactate.

8. A recording medium for an aqueous ink, comprising:
an impermeable base member;
an undercoat layer formed on a surface of the base member,
wherein the undercoat layer includes a binder resin, porous resin fine particles, 2,5,8,11-tetramethyl-6-dodecyne-5,8-diol, and a polyvalent metal salt.

9. The recording medium according to claim 8, wherein
the undercoat layer further includes a surface tension adjuster.

10. The recording medium according to claim 9, wherein
the undercoat layer further includes a water-soluble organic solvent.

11. The recording medium according to claim 8, wherein
the porous resin fine particles are formed of a copolymer of a styrene resin and an acrylic resin.

12. The recording medium according to claim 11, wherein
the undercoat layer further includes a penetrating agent.

13. The recording medium according to claim 12, wherein
the penetrating agent includes 3-methoxy-3-methyl-1-butanol.

14. The recording medium according to claim 13, wherein
the polyvalent metal salt includes calcium lactate.
